(19) United States
(12) Patent Application Publication
(10) Pub. No.: US 2015/0356272 A1
(43) Pub. Date: Dec. 10, 2015

(54) PRESCRIPTION ANALYSIS SYSTEM AND METHOD FOR APPLYING PROBABILISTIC MODEL BASED ON MEDICAL BIG DATA

(71) Applicant: TAIPEI MEDICAL UNIVERSITY, TAIPEI CITY (TW)

(72) Inventors: YU-CHUAN LI, TAIPEI CITY (TW); WEN-SHAN JIAN, TAIPEI CITY (TW); PHUNG ANH NGUYEN, TAIPEI CITY (TW); SHABBIR SYED-ABDUL, TAIPEI CITY (TW)

(21) Appl. No.: 14/300,256

(22) Filed: Jun. 10, 2014

(51) Int. Cl. G06F 19/00

(52) U.S. Cl. CPC G06F 19/3456

(57) ABSTRACT

A prescription analysis system and method are introduced. The prescription analysis system includes a knowledge database, an access module, a storage module, and a judgment module. The judgment module judges whether a new prescription is appropriate according to three prescription appropriateness criteria. The prescription analysis method is integrated in the prescription analysis system. Therefore, the prescription analysis system and method enhance the accuracy of prescriptions, reduce likelihood of medication errors, cut medical expenditure, and save patients' lives.

### FIELD OF TECHNOLOGY

The present invention relates to a prescription analysis system and method for applying a probabilistic model in order to detect uncommon or rare medications prescribed in prescriptions.

### BACKGROUND

The wheel of time turns and medical advances are increasingly effective in curing human diseases. Medications are one of the most powerful tools in modern medicine used for the treatment of diseases.

On the other hand, due to rapid changes in health information systems, health data gathered by health providers are increasing dramatically. The health data resides in multiple places, both structured and unstructured, like individual electronic medical record system (EMRs), lab and imaging systems, physician notes, medical correspondence, claims, CRM systems and finance. The amount of information associated with the health of an individual has grown exponentially in recent years. The information generated by an increasing number of pharmaceuticals, laboratory tests, new and more sophisticated imaging studies, and detailed genetic information is nowadays too much to be processed by individual physicians. Thus, data can be “big” in different ways and is seldom free of medication errors.

Nonetheless, medication errors, which are not uncommon, compromise patients' health or even causing the patients to end up with life-threatening conditions, but also adding to medical expenditure greatly and insidiously. This will happen, if a physician gives no considerations to a patient's condition when prescribing a prescription or in case of cross reaction between medications prescribed by different specialists.

Statistics reported that nearly 100,000 individuals die per year in the United States due to preventable medical errors, most of which are medication errors. In addition, studies also reported 39% of medication errors occur during prescribing; 12% occur during transcribing at the pharmacy; 11% occur during compounding at the pharmacy, and 39% occur during administration as well as only 2% of medication errors are intercepted at some point in the medication administration process.

However, some studies report that medication errors can be reduced by information technology (IT), such as computerized physician order entry (CPOE) system. Thus, reducing medication errors and thereby improving medical treatment is crucial to evaluating hospital performance and improving prognosis of patients. It also cuts health care costs by providing ordering automation, a key process in modern health care. Such processes include CPOE with clinical decision support, bar-coded medication administration, automated dispensing systems (ADS), and dose drug distribution. Bates D. W. et al. claim that the key tools for reducing this gap will be information systems that provide decision support to users at the time they make decisions, which results in improving quality of health care. Thus, the knowledge-based CDS review can assure that the orders are safe and comply with guidelines.

Most knowledge-based systems are implemented for automated methods statistically developed and maintained by experts at a significantly high cost to keep promises and give evidence. Moreover, most of them are “rule-based” methods that have been used to support decision-making in classification and association tasks. According to the present invention, to improve the efficiency of detecting medication errors, we used a set of data mining techniques for identifying the association between disease-medication and medication-medication in order to develop a probabilistic model to detect inappropriate prescriptions.

### SUMMARY

As described above, it is understood that the present medical technology can be the key tools for reducing this gap in medical errors. By taking the advantage of “big data” that can be found in researches, it provides many examples related to big data in order to improve patients safety. The main purpose of the present invention is to provide a prescription analysis system for applying a probabilistic model based on medical big data, and provide a prescription analysis method integrated in the prescription analysis system, to achieve reduction of medication errors, enhancement of health care quality, and medical cost cutting.

The essential spirit of the present invention is detecting the uncommon medication prescribed by using a set of automation techniques to identify the association in between disease-medication and medication-medication. According to the present invention, the medical big data is processed to develop a probabilistic model as well as a reminder system to remind physicians to write appropriate prescriptions. Statistical analysis is performed to evaluate the accuracy of the system. Therefore, the present invention can provide a tool which is able to identify inappropriate prescriptions as well as to aid in improving patient safety and quality of health care.

The prescription analysis system of the present invention comprises: a knowledge database for holding medical big data including all associations in between Disease-Medication and Medication-Medication with their association strength values denoted by Q; an access module for accessing disease code, medication code, patient info, and physician info, which are included in the new prescription, and sending the disease code, medication code, patient info, and physician info to a storage module; the storage module for storing the disease code, medication code, patient info, and physician info; and a judgment module for estimating a prediction of the prescriptions read and stored by the access module. The process flow of the prescription analysis method of the present invention comprises a data processing step, a knowledge database creating step, an accessing step, a storing step, an estimating step, and a reminding step.

In order for the nature of the present invention to be more clearly understood, preferred forms thereof are hereunder described with reference to the following Examples, Figures and Tables.

### BRIEF DESCRIPTION

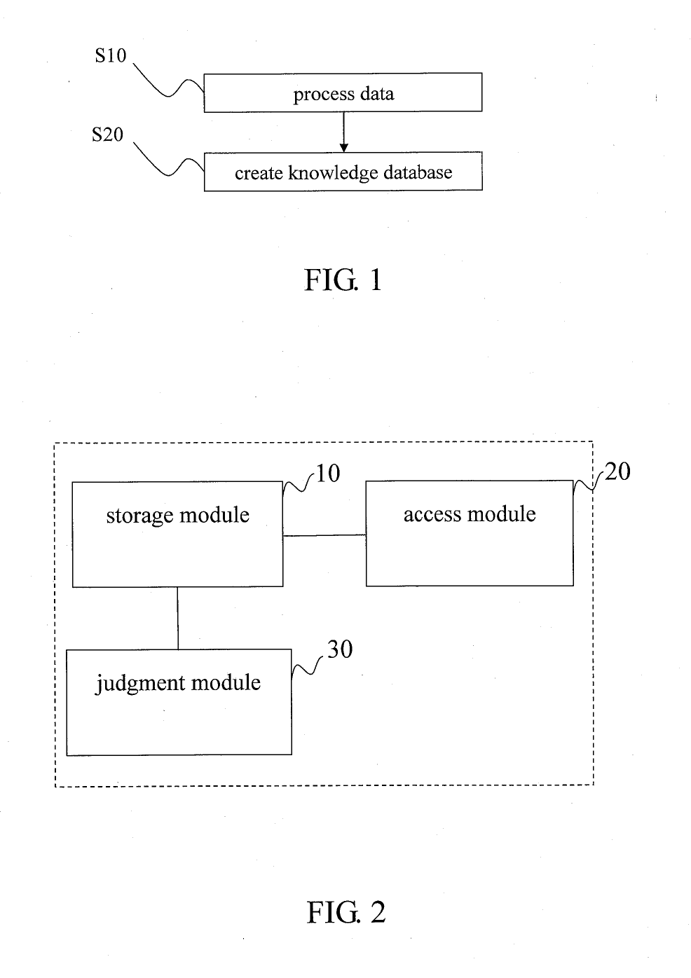

FIG. 1 is a schematic view of the process flow of creating a knowledge database according to an embodiment of the present invention;

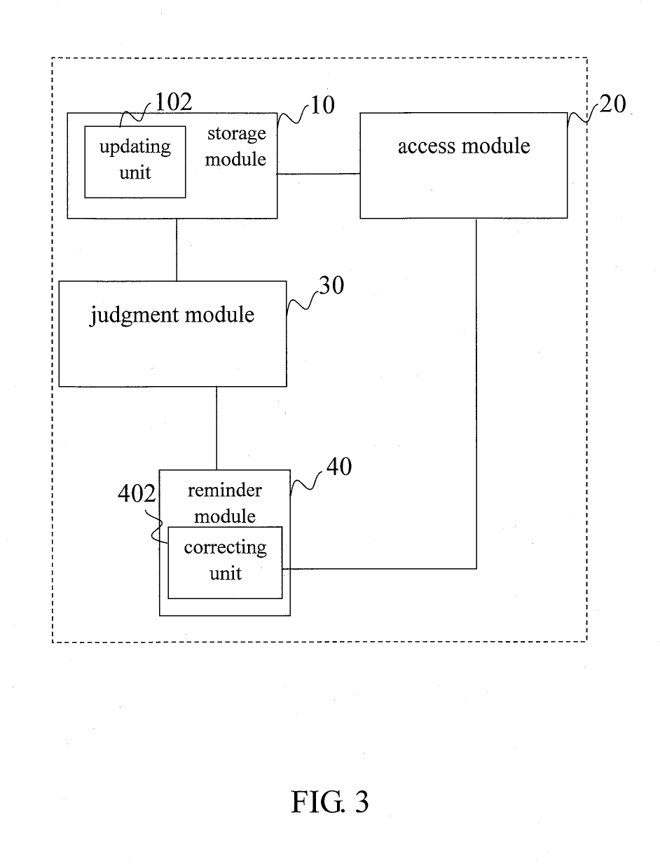

FIG. 2 and FIG. 3 are block diagrams of a prescription analysis system according to an embodiment of the present invention;

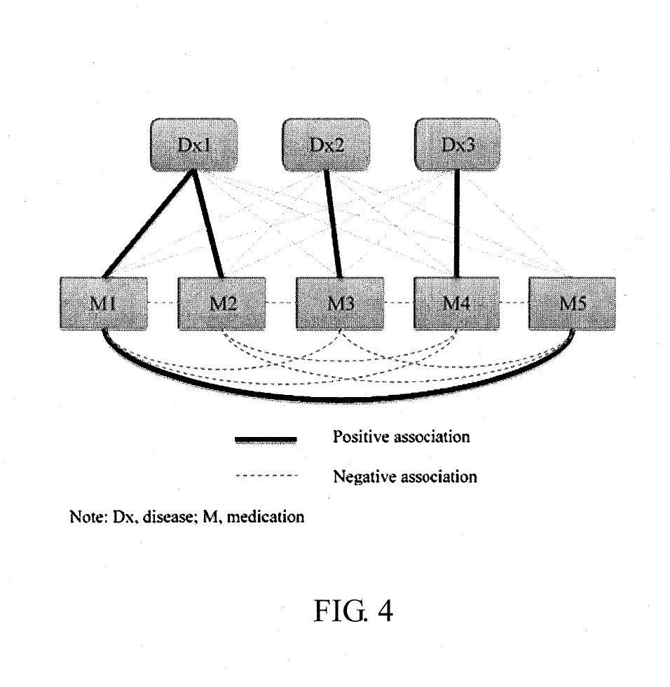

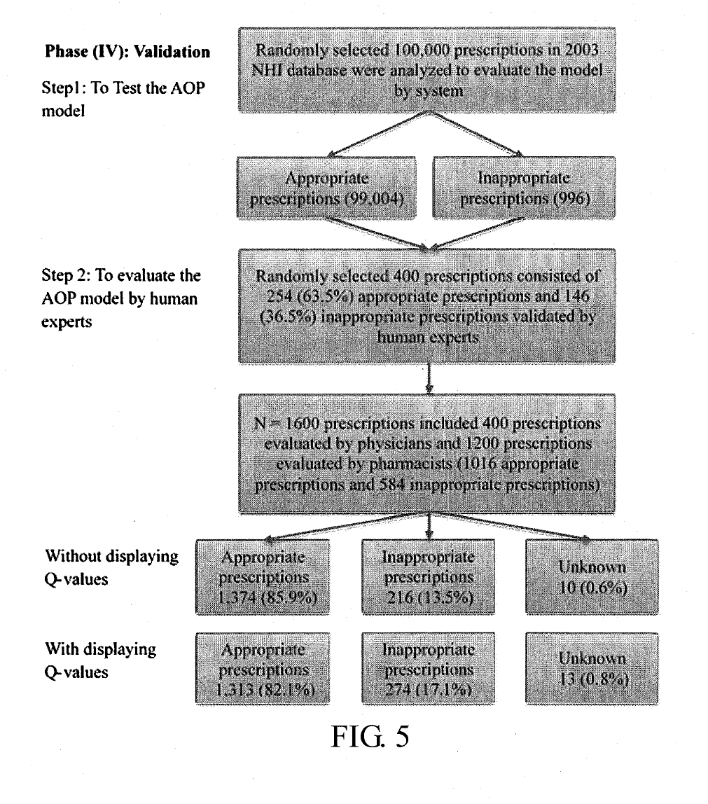

FIG. 4 is a schematic view of an example of a prescription according to an embodiment of the present invention;

FIG. 5 is a flow chart of validating the AOP model according to an embodiment of the present invention; and

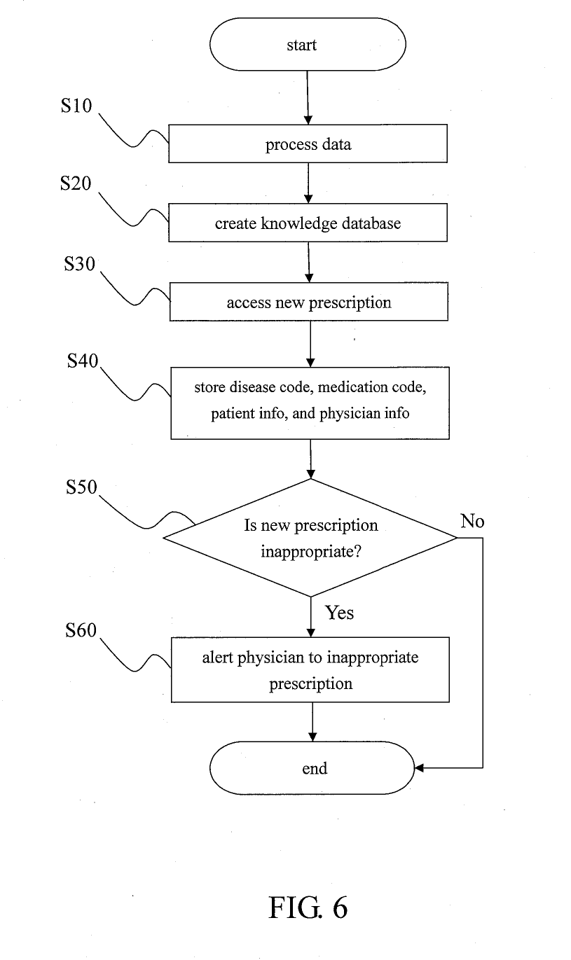

FIG. 6 is a flow chart of a prescription analysis method according to an embodiment of the present invention.

### DETAILED DESCRIPTION

### (I) Creating Knowledge Database

The present invention embodies automated techniques for identifying the associations among disease-medication as well as medication-medication and computing their association strength. FIG. 1 is a schematic view of the process flow of creating a knowledge database for storing medical big data. As shown in FIG. 1, the process flow of creating the knowledge database includes a data processing step and a database creating step. All disease-medication (DM), medication-medication (MM) association, and their association strength which are derived from medication big data (i.e. prescriptions), are stored in knowledge database. The following example illustrates the knowledge database whose medical big data are borrowed from the Taiwan National Health Insurance Research Database.

### Data Processing

The Taiwan's National Health Insurance (NHI) claims data from 2002 with a total of 263.6 million prescriptions is collected. All data are about out-patient visits from hospitals and clinics in Taiwan. Each record—prescription consists of the date of visit, patient's pseudo-ID, age, gender, primary diagnosis and secondary diagnosis in NHI codes. Each prescription also includes one to three diagnostic codes and 1 to 15 medication codes. We exclude 160.1 million prescriptions due to the following reasons: a) missing or invalid disease codes or medication codes; b) the use of traditional Chinese medicine prescriptions. Thus, the remaining 103.5 million prescriptions with 204.5 million diagnosis ICD9-CM (International Classification of Disease v.9-Clinical Modification) codes and 347.7 million medications with the Taiwan NHI codes are used in the analysis. These medication codes are mapped to the ATC (Anatomical Therapeutic Chemical) classification code system. The dataset consists of 13,070 unique ICD9-CM codes and 1,548 unique ATC codes.

### Creating Database

According to an embodiment of the present invention, the combination of disease-medication and medication-medication are associated as a result of their co-occurrence in a prescription for each patient's visit to a physician.

Although association rules can be filtered by their support and confidence, there are often many more potential rules produced through these techniques than can be manually reviewed. A variety of measures of “interestingness” have been proposed which can be used to filter these item sets and association rules. In the present invention, we focus our attention on a robust measures of “interestingness” as lift value hereinafter referred to as Q value.

Definition of Q: Q value is the ratio between the joint probability of disease-medication and medication-medication with respect to their expected probability under the independent assumption.

The association strength value of disease-medication and medication-mediation are denoted by QDM and QMM respectively. Based on this definition, each DM and MM pair association strength is computed using 2×2 table (see Table 1). In this table, for a given rule (X->Y), ‘a’ presents the number of transactions in the database containing both X and Y, ‘b’ the number containing X but not Y, ‘c’ the number containing Y but not X and ‘d’ the number containing neither X nor Y. C₁ and C₂ are the total number of prescriptions prescribed with disease and medication respectively.

TABLE 1

| | Medication Y | Medication Y | |
|---|---|---|---|
| | present | not present | |
| Disease X present | a | b | a + b (C₁) |
| Disease X not present | c | d | |
| | a + c (C₂) | | N |

$${Q}_{XY} = \frac{P ( X , Y )}{P ( X ) * P ( Y )} = \frac{P ( X \vert Y )}{P ( X )} = \frac{\frac{A}{N}}{\frac{( A + B )}{N} * \frac{( A + C )}{N}} \qquad Formula 1$$

According to Formula 1, Q_{XY} is defined in [0,+∞]; with Q=1 indicates no association between disease and medication, Q<1 indicates that disease and medication are negatively associated (i.e. negative QDM), and Q>1 indicates that disease and medication are positively associated (i.e. positive QDM—the prescriptions with disease X containing medication Y occur more often than other medications).

After computing all of observed DM and MM associations, we created a database (term as NHI database) that has a total of 1.34 million DM and 0.65 million MM pairs with their Q values. The DM and MM associations with less than 5 co-occurrences, by default are considered as “uncommon or rare associations” and are not included in developing the system. Moreover, according to the present invention, the cut-off value for Q is 1. For any association (DM or MM) having Q value less than 1 is regarded as a negative association or uncommon association. The cut-off value can able be adjusted to improve the system.

### (II) Developing Prescription Analysis System

It is an objective is to provide an analysis system by applying a probabilistic model that used wherein the cause and effect relationship is stochastically or randomly between disease and medication (DM) or medication and medication (MM) via medical big data. It could be used to identify the uncommon or rare medication prescribed in a new prescription.

In order to achieve the above objectives, the present invention provides a prescription analysis system for analyzing prescriptions and evaluating their appropriateness. The prescription analysis system identifies a prescription as appropriate if medication(s) prescribed the prescription match(es) the disease(s) diagnosed and stated in prescription. Referring to FIG. 3, the prescription analysis system essentially comprises an access module 20, a judgment module 30, and a storage module 10.

### Access Module

The access module 20 firstly receives the prescriptions with their diseases as ICD-9-CM (International Classification of Disease v.9-Clinical Modification) codes and medication as ATC (Anatomical Therapeutic Chemical) system codes corresponding for diseases in treatment of patients. Subsequently, the access module stores all information in the storage module 10. Furthermore, the access module 20 also receives related information such as patients' pseudo-ID, physicians' ID and the date of prescribing prescriptions.

### Judgment Module

The judgment module 30 estimates the prediction of prescriptions that are read and stored by the access module 20. The judgment module 30 checks each DM and MM association strength of the prescription in the access module 20. Afterward, the judgment module 30 identifies the prescription as appropriate based on the number of DM and MM association strength termed as an appropriateness of prescription (AOP) model. The AOP model considers the prescription appropriate if it satisfies the following rules:
1) The total number of positive Q_{DM} and positive QMM should be greater than or equal to the number of medications;
2) All diagnoses should have at least a positive QDM; and
3) Each medication in a new prescription should have at least a positive Q_{DM} or positive Q_{MM}.

The AOP model is expressed mathematically as:

$$\{ \begin{matrix}\{ {Q}_{{D}_{i} {M}_{j}} \} + \{ {Q}_{{M}_{j} {M}_{k}} \} \geq m \\ ∃ {Q}_{{D}_{i} {M}_{j}} \text{:} \{ {Q}_{{D}_{i} {M}_{j}} \} \geq α \\ ∀ M : [ \begin{matrix}∃ {Q}_{{D}_{i} {M}_{j}} \text{:} \# \{ {Q}_{{D}_{i} {M}_{j}} \} \geq α \\ ∃ {Q}_{{M}_{j} {M}_{k}} \text{:} \# \{ {Q}_{{M}_{j} {M}_{k}} \} \geq α\end{matrix}\end{matrix} ( \begin{matrix}i ∈ \{ 1 , 2 … n \} ; j , \\ k ∈ \{ 1 , 2 … m \}\end{matrix} ) \qquad Formula 2$$

In formula 2, n is the number of diagnoses; m is the number of medications; α is cut-off value; Q_{DiMJ} is a DMQ; Q_{MjMk} is a MMQ in the same prescription. In the present invention, a is 1 by default.

FIG. 4 is a schematic view of an example of a prescription, where Dx1, Dx2, and Dx3 are the disease codes in the prescription, and M1, M2, M3, M4, M5 are the medication codes. The association strength of DM and MM is accessed by the judgment module 30 in which Q_{Dx1M1}, Q_{Dx1M2}, Q_{Dx2M2}, Q_{Dx3M4}, Q_{M1M4} are considered positive association.

### Storage Module

The storage module 10 stores all prescriptions prescribed by physicians. ICD-9-CM diseases codes and ATC medication codes of prescriptions are initially stored in the storage module 10. The prescriptions which are modified by physicians with their disease and medication codes, are stored in order to estimate and compare the change of medications prescribed by an updating unit 102 of the storage module 10 (see FIG. 3).

### Reminder Module

The prescription analysis system further comprises a reminder module 40 which responds automatically by sending a reminder to the access module 20 if the prescriptions are considered inappropriate. The reminder module 40 further comprises a correcting unit 402. The correcting unit 402 corrects the uncommon or rare medication codes/names prescribed in a new prescription.

### AN EXAMPLE OF UTILIZING THE INVENTION

In the process of developing the analysis system, we also test and evaluate the system by human experts. Firstly, the system undergoes an initial testing based on the verifying dataset. Subsequently, the system undergoes a second evaluation by human experts including four physicians and three clinical pharmacists to measure the accuracy of the AOP model and the system as well.

FIG. 5 is a flow chart of validating the AOP model according to an embodiment of the present invention.

To test AOP model

100,000 prescriptions are randomly selected from the 2003 NHI claims database. Afterward, the AOP model is used to test the selected prescriptions for appropriateness.

### The Evaluation of AOP Model by Human Experts

400 prescriptions are randomly selected out of 100,000 prescriptions which are tested by our AOP model. The 400 prescriptions selected to be evaluated by experts include 254 (63.5%) appropriate prescriptions and 146 (36.5%) inappropriate prescriptions. In order to facilitate the identification and measurement of prescriptions, all experts are explained the purpose of the study and are asked to mark whether they agree, disagree or are unsure regarding the overall prescriptions data provided to them. Next, the same prescriptions are re-evaluated with two types of questionnaires—with and without showing Q value for each DM association present in the prescription. The appropriate and inappropriate prescriptions are identified and mixed within the same questionnaire. We administer the questionnaires to four physicians at their clinics (two hundred prescriptions each physician) and three clinical pharmacists (eight hundred prescriptions each pharmacist) at the hospital pharmacies. The questionnaires without Q values are filled out first by all experts, followed by the questionnaires with Q values. Overall, we administer 3,200 prescriptions (1,600 prescriptions without Q values and 1,600 prescriptions with Q values).

The sensitivity, specificity, positive predictive value (PPV), and negative predictive value (NPV) are computed from the results obtained in order to compare the differences and the consensus between the system and experts.

### Results of Testing AOP Model

From a total of 100,000 prescriptions, 99,004 prescriptions (99.004%) are identified as appropriate and 996 prescriptions (0.996%) are identified as inappropriate by the AOP model.

### Results of Evaluation of AOP Model by Experts

When the Q values are not disclosed, the experts respond to 1590 (99.3%) prescriptions of which 1,374 (85.9%) are appropriate and 216 (13.5%) are inappropriate prescriptions, leaving 10 prescriptions as “unknown”. However, when the Q value are shown in the prescriptions, the experts respond only to 1,587 (99.2%) prescriptions in which 1,313 (82.1%) are appropriate, 274 (17.1%) are inappropriate prescriptions, and 13 prescriptions are classified as “unknown” (see FIG. 6)

TABLE 2

| Human | Without DMQs, % | | | | With DMQs, % | | | |
|---|---|---|---|---|---|---|---|---|
| experts | Sens | Spec | PPV | NPV | Sens | Spec | PPV | NPV |
| Physicians | 74.3 | 82.7 | 94.8 | 43.1 | 76.7 | 84.9 | 94.8 | 50.3 |
| Pharmacists | 68.8 | 75.0 | 95.6 | 24.6 | 74.3 | 94.2 | 98.7 | 40.6 |
| Overall | 71.5 | 78.9 | 95.2 | 33.9 | 75.5 | 89.5 | 96.7 | 45.5 |

Abbreviation:
Sens, sensitivity;
Spec, specificity;
PPV, positive predictive value;
NPV, negative predictive value.
Note:
Confidence intervals (CIs) are small for each parameter and are thus omitted from the reported results.

The accuracy of the system assessed by clinical pharmacists and results obtained are shown in table 2. When the Q are disclosed, the average sensitivity, PPV and NPV are 68.8%, 95.6%, and 24.6% of the pharmacists, respectively. The change found in the questionnaires with showing Q values is different to the change in the questionnaires without showing Q values. However, the average sensitivity, PPV and NPV are 74.3%, 98.7%, and 40.6%, respectively.

Based on the results described above, the present invention provides a prescription analysis system which uses a probabilistic model as an efficient tool in automatically identifying uncommon or rare associations between disease-medication and medication-medication in prescriptions. The prescription analysis system helps to not only reduce medication errors by alerting physicians to the inappropriate prescriptions identified, but also improve the patients' safety and the overall quality of health care.

The present invention further provides a prescription analysis method integrated in the prescription analysis system. Referring to FIG. 6, there is shown a flow chart of the prescription analysis method. As shown in the diagram, the process flow of the prescription analysis method comprises the steps of: S20 creating the knowledge database; S30 accessing, by the access module, disease code, medication code, patient info, and physician info included in the new prescription; S40 storing the disease code, medication code, patient info, and physician info in the storage module; and S50 estimating, by the judgment module, a prediction of the new prescription read by the access module and stored in the access module.

The knowledge database creating step S20 is preceded by a data processing step S10 which entails mapping the medication codes to the Anatomical Therapeutic Chemical (ATC) classification code system.

In the estimating step S50, the prediction of the new prescription entails determining whether the new prescription is inappropriate. If the estimating step S50 determines that the new prescription is inappropriate, the estimating step S50 will be followed by a reminding step S60 executed with the reminder module for alerting the physician to the inappropriate prescription.

1. A prescription analysis system for determining appropriateness of a new prescription, comprising:
a knowledge database for holding medical big data including all associations in between Disease-Medication and Medication-Medication with their association strength values denoted by Q;
an access module for accessing disease code, medication code, patient info, and physician info, which are included in the new prescription, and sending the disease code, medication code, patient info, and physician info to a storage module;
the storage module for storing the disease code, medication code, patient info, and physician info; and
a judgment module for estimating a prediction of the prescriptions read and stored by the access module.

2. The prescription analysis system of claim 1, wherein the association strength values of disease-medication and medication-medication are generated by an automated technique and store in the knowledge database, and the association strength values are indicative of one of no association, positive association, and negative association.

3. The prescription analysis system of claim 2, wherein the judgment module evaluates and identifies the new prescription as appropriate based on a number of DM and MM association strength termed as an appropriateness of prescription (AOP) model.

4. The prescription analysis system of claim 3, further comprising a reminder module connected to the judgment module and adapted to send a reminder to the physician of the new prescription in response to confirmed identification of an uncommon medication prescribed.

5. A prescription analysis method integrated in the prescription analysis system of claim 1, the prescription analysis method comprising the steps of:
creating the knowledge database;
accessing, by the access module, disease code, medication code, patient info, and physician info included in the new prescription;
storing the disease code, medication code, patient info, and physician info in the storage module; and
estimating, by the judgment module, a prediction of the new prescription read by the access module and stored in the access module.

6. The prescription analysis method of claim 5, wherein the knowledge database creating step is preceded by a data processing step which entails mapping the medication codes to the Anatomical Therapeutic Chemical (ATC) classification code system.

7. The prescription analysis method of claim 5, wherein, in the estimating step, the prediction of the new prescription entails determining whether the new prescription is inappropriate.

8. The prescription analysis method of claim 7, wherein, if the estimating step determines that the new prescription is inappropriate, the estimating step will be followed by a reminding step executed with the reminder module for alerting the physician to the inappropriate prescription.
